(19) United States
(12) Patent Application Publication
(10) Pub. No.: US 2026/0194335 A1
(43) Pub. Date: Jul. 9, 2026

(54) SLOTTED TAPE MEASURE HOOK

(71) Applicant: James Hart, Milo, MO (US)

(72) Inventor: James Hart, Milo, MO (US)

(21) Appl. No.: 19/558,204

(22) Filed: Mar. 5, 2026

Related U.S. Application Data
(60) Provisional application No. 63/843,008, filed on Jul. 13, 2025.

(51) Int. Cl. G01B 3/1089; G01B 3/10; G01B 3/1056

(52) U.S. Cl. CPC G01B 3/1089; G01B 3/1056; G01B 2003/1058

(57) ABSTRACT

A measuring and cutting system includes a tape measure including a flexible tape extending along a longitudinal axis and having a distal end, and a hook secured to the distal end of the flexible tape. The hook includes a proximal attachment portion secured to the distal end of the flexible tape, a distal flange portion extending perpendicular to the longitudinal axis, and a slot configured to receive a blade of a cutting tool.

### CROSS-REFERENCE TO RELATED APPLICATIONS

This application claims the benefit of U.S. patent application Ser. No. 63/843,008, filed Jul. 13, 2025, and titled “Slotted Steel Tape Measure Hook,” the disclosure of which is incorporated herein by reference.

### BACKGROUND

Cutting construction materials, such as, but not limited to, drywall and foam insulation, may involve manual cutting with a utility knife. This may be done by either following a chalk line drawn manually by hand, or by manually holding a blade of the utility knife against a hook of a tape measure by hand. These manual processes can be time-consuming and potentially unsafe due to the proximity of a user's hand to the blade of the utility knife.

Accordingly, there is a need for a tape measure hook including a slot to receive a blade of a utility knife to improve the efficiency of manual cutting and the safety of the user, and a method of using the same.

### BRIEF SUMMARY

In one aspect, a measuring and cutting system is described. The measuring and cutting system includes a tape measure including a flexible tape extending along a longitudinal axis and having a distal end, and a hook secured to the distal end of the flexible tape. The hook includes a proximal attachment portion secured to the distal end of the flexible tape, a distal flange portion extending perpendicular to the longitudinal axis, and a slot formed in the distal flange portion and configured to receive a blade of a cutting tool.

In another aspect, a tape measure hook is described. The tape measure hook includes a hook body including a proximal attachment portion and a distal flange portion bent relative to the proximal attachment portion, one or more fastener apertures formed in the proximal attachment portion and configured to secure the hook body to a distal end of a tape measure blade, and a slot formed through the distal flange portion and configured to receive a blade of a cutting tool.

In yet another aspect, a method of using a tape measure hook having a slot configured to receive a blade of a cutting tool is described, the tape measure hook being secured to a distal end of a flexible tape of a tape measure. The method includes inserting a blade of a cutting tool into the slot of the tape measure hook, and moving the cutting tool relative to the workpiece while maintaining the blade within the slot to guide cutting along a line corresponding to the selected measurement length.

### BRIEF DESCRIPTION OF THE DRAWINGS

To easily identify the discussion of any particular element or act, the most significant digit or digits in a reference number refer to the figure number in which that element is first introduced.

FIG. 1 is a top view of a system including a tape measure and a tape measure hook.

FIG. 2 is a top view of a slot of the tape measure hook of FIG. 1.

FIG. 3 is a side perspective view of the system of FIG. 1.

FIG. 4 is another side perspective view of the system of FIG. 1.

FIG. 5 is a flowchart of a method of using a system including a tape measure and a tape measure hook.

### DETAILED DESCRIPTION

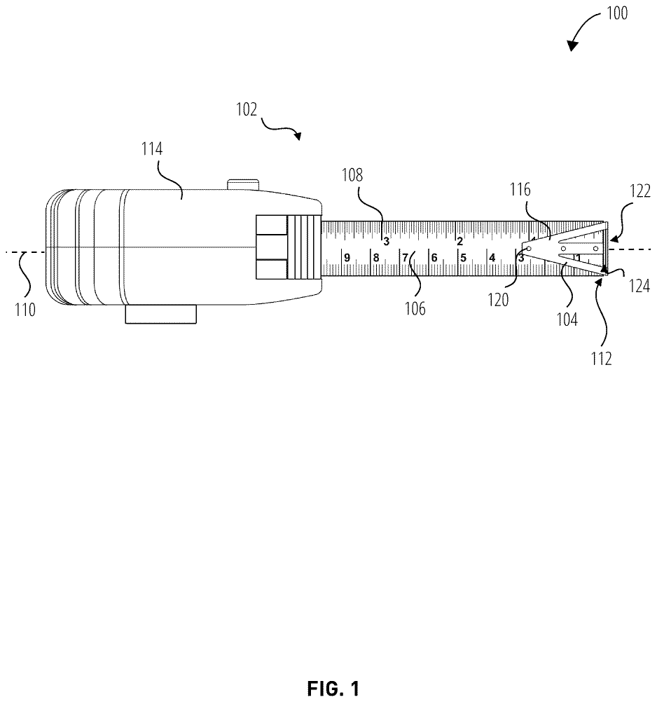

FIG. 1 illustrates a measuring and cutting system 100. Specifically, FIG. 1 is a top view of the measuring and cutting system 100 including a tape measure 102 and a tape measure hook 104. The tape measure 102 includes a tape 106. The tape 106 may include a plurality of measurement markings 108 disposed along a longitudinal axis 110 of the tape 106 to indicate linear units of measurement. In some embodiments, the tape 106 may be formed from spring steel, stainless steel, coated steel, composite material, or other flexible measuring material. The tape 106 extends to a distal end 112, which may be used as an endpoint for a longitudinal length as measured by the tape measure 102.

The tape measure 102 may include a housing 114 configured to receive the tape 106 in a coiled configuration and a recoil mechanism (not shown) disposed within the housing 114. In some embodiments, the housing 114 and the recoil mechanism (not shown) may be configured to withstand forces, such as, but not limited to, lateral forces, transmitted through the tape measure hook 104 during use, such as during guided cutting operations as described herein. The recoil mechanism (not shown) may be operatively coupled to the tape 106 to bias the tape 106 toward a retracted position within the housing 114. During operation, the distal end 112 of the tape 106 may be withdrawn from the housing 114 against the bias of the recoil mechanism (not shown) to a desired length. The illustration of the tape measure housing in FIG. 1 is intended merely as an example, and is not meant to be limiting. That is, other embodiments of a tape measure housing are intended to be covered by the present disclosure.

The tape measure 102 may including a locking mechanism (not shown) configured to selectively restrain movement of the tape 106 relative to the housing 114 during operation. For example, the locking mechanism (not shown) may include a user-actuatable member (not shown) that is operatively engageable with the tape 106 to frictionally hold the tape 106 at a selected extended length. The locking mechanism (not shown) may be engaged prior to inserting a blade into the slot 124 to stabilize the tape measure 102 during cutting, such as the blade of the cutting tool described further herein.

As shown in FIG. 1, the distal end 112 of the tape 106 is coupled to the tape measure hook 104. When the distal end 112 of the tape 106 is withdrawn from the housing (not shown) to a desired length for measuring, the tape measure hook 104 may be positioned relative to material for measurement. Once the tape measure hook 104 is positioned as needed for measuring the material, the measurement markings 108 on the tape 106 may be used to determine a measured dimension of the material.

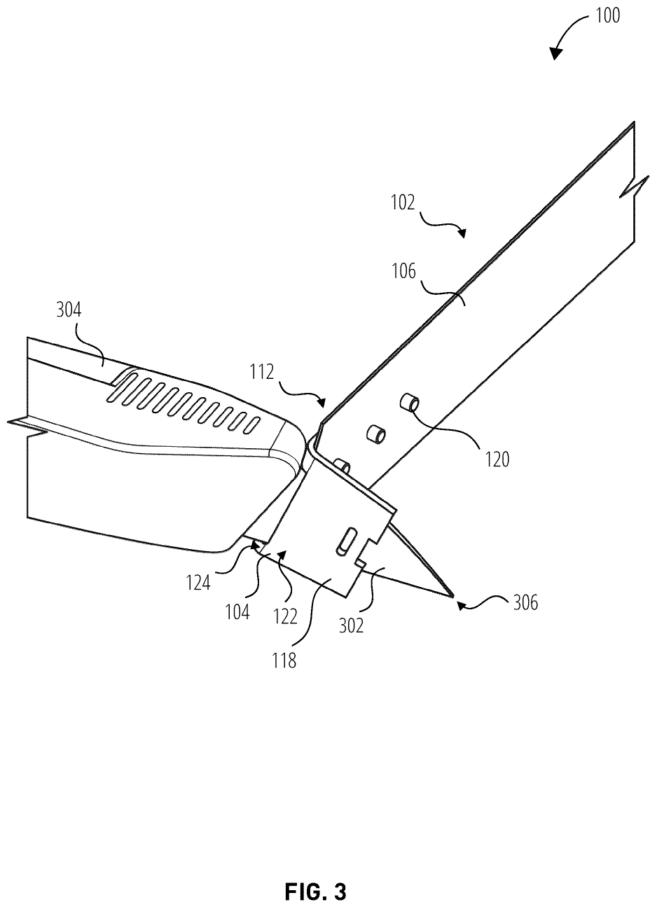

The tape measure hook 104 includes a proximal attachment portion 116 and a distal flange portion 118 (shown in FIG. 3). The proximal attachment portion 116 overlies the distal end 112 of the tape 106 and may be secured to the tape 106 by one or more fasteners 120. The fasteners 120 may include rivets, pins, screws, or other mechanical fastening members. In some embodiments, the fasteners 120 may extend through elongated apertures formed in the tape 106 to permit limited axial movement of the tape measure hook 104 relative to the tape 106 to compensate for the thickness of the distal flange portion 118 during measurements.

The distal flange portion 118 (shown in FIG. 3) is bent or formed at an angle relative to the proximal attachment portion 116 so as to extend generally perpendicular to the longitudinal axis 110 of the tape 106. As such, the distal flange portion 118 (shown in FIG. 3) defines a contact edge 122 configured to abut a specific surface of material for measurement, such as, but not limited to, an edge or a corner, to establish a measurement reference point. In some embodiments, the distal flange portion 118 (shown in FIG. 3) may include reinforced regions, folded edges, ribs, embossments, or increased material thickness to improve rigidity during use and/or cutting. The body of the tape measure hook 104 may be formed from stamped steel, hardened steel, stainless steel, or other rigid materials capable of maintaining slot geometry under cutting loads.

The tape measure hook 104 includes a slot 124. The slot 124 is positioned between the proximal attachment portion 116 and the distal flange portion 118, and is dimensioned to receive a blade of a cutting tool, such as, but not limited to, a blade of a utility knife, therein.

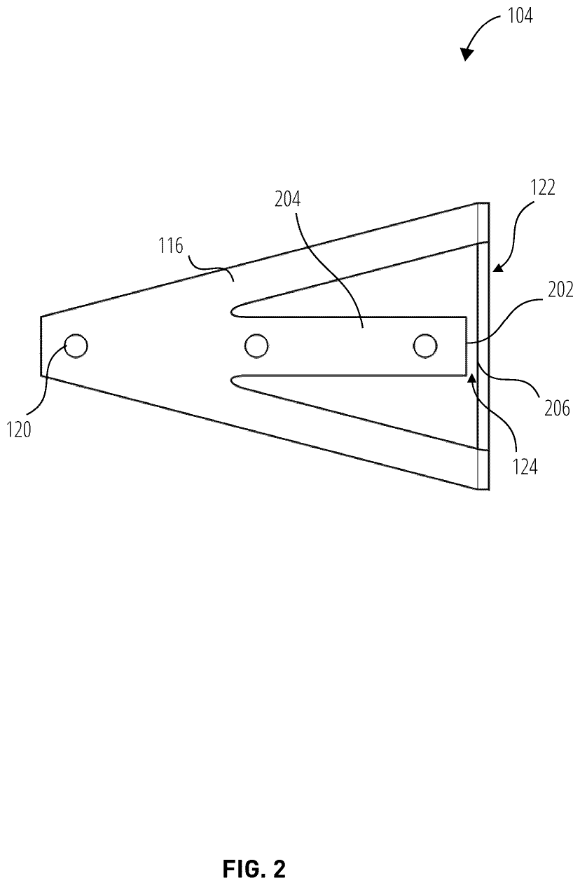

FIG. 2 is a top view of the tape measure hook 104. The slot 124 may be formed by a first sidewall 202 of a middle extension member 204 of the proximal attachment portion 116 and a second sidewall 206 of the distal flange portion 118.

FIG. 3 is a side perspective of the measuring and cutting system 100, including the tape measure 102 and the tape measure hook 104. As shown in FIG. 3, a blade 302 of a cutting tool 304 may be received by the slot 124 of the tape measure hook 104. The slot 124 may be configured to receive the blade 302 substantially perpendicular to the longitudinal axis 110 (shown in FIG. 1) of the tape 106.

The first sidewall 202 (shown in FIG. 2) and the second sidewall 206 (shown in FIG. 2) may define a width corresponding substantially to a thickness of a blade to be received by the slot 124, such as, but not limited to, the blade 302 of the cutting tool 304. Thus, once the blade 302 is inserted into the slot 124, the slot 124 may laterally restrain movement of the blade 302 and/or frictionally retain the blade 302. In some embodiments, the slot 124 may include one or more blade retention features, such as, but not limited to, dents, tabs, magnetic elements, ribs, inserts, or other retention structures, configured to resist unintentional withdrawal of the blade 302 during cutting.

A tip 306 of the blade 302 may protrude through the slot 124 when the blade 302 is received by the slot 124. In some embodiments, the slot 124 may include a tapered entry region to guide insertion of the blade 302. The slot 124 may be partially enclosed or configured to limit the insertion depth of the blade 302.

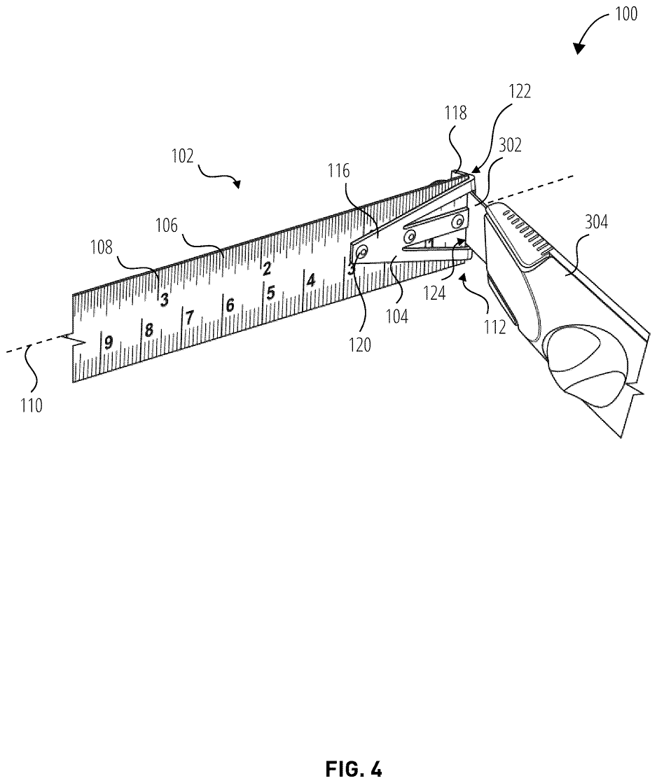

FIG. 4 is another side perspective of the measuring and cutting system 100.

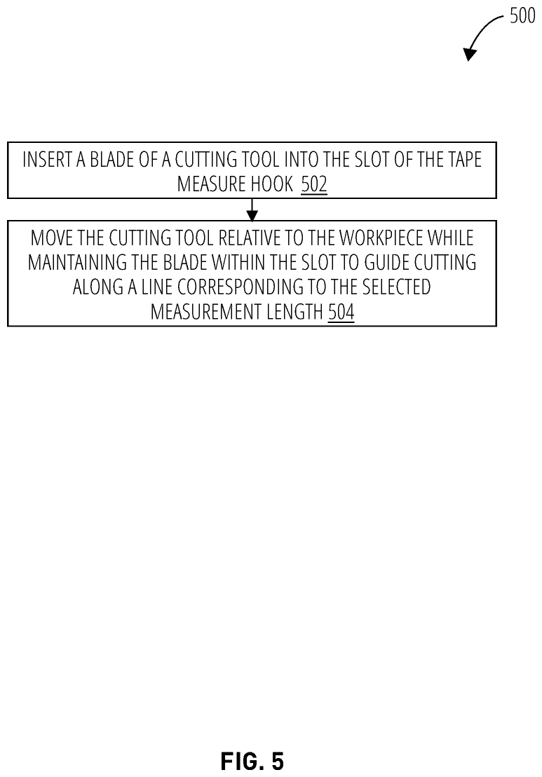

FIG. 5 is a flowchart of a method 500 of using a system including a tape measure and a tape measure hook, such as, but not limited to, the measuring and cutting system 100. The method includes

[symbol]

What is claimed is:

1. A measuring and cutting system comprising:
a tape measure including a flexible tape extending along a longitudinal axis and having a distal end; and
a hook secured to the distal end of the flexible tape,
wherein the hook includes:
a proximal attachment portion secured to the distal end of the flexible tape;
a distal flange portion extending perpendicular to the longitudinal axis; and
a slot configured to receive a blade of a cutting tool.

2. The measuring and cutting system of claim 1, wherein the slot is dimensioned to frictionally retain the blade.

3. The measuring and cutting system of claim 1, wherein the slot includes opposing sidewalls defining a width corresponding to a thickness of a utility blade.

4. The measuring and cutting system of claim 1, wherein the proximal attachment portion is secured to the flexible tape by one or more fasteners extending through elongated apertures in the flexible tape.

5. The measuring and cutting system of claim 4, wherein securing the proximal attachment portion to the flexible tape permits limited axial movement of the hook relative to the flexible tape.

6. The measuring and cutting system of claim 1, wherein the slot extends generally perpendicular to the longitudinal axis.

7. The measuring and cutting system of claim 1, wherein the slot includes a blade retention feature.

8. A tape measure hook comprising:
a hook body including a proximal attachment portion and a distal flange portion bent relative to the proximal attachment portion;
one or more fastener apertures formed in the proximal attachment portion and configured to secure the hook body to a distal end of a tape measure blade; and
a slot configured to receive a blade of a cutting tool.

9. The tape measure hook of claim 8, wherein the slot extends in a direction generally perpendicular to a longitudinal axis of the tape measure blade.

10. The tape measure hook of claim 8, wherein the slot includes opposing sidewalls configured to laterally restrain movement of the blade.

11. The tape measure hook of claim 8, wherein the slot is configured to receive the blade with a tip of the blade protruding beyond the distal flange portion.

12. The tape measure hook of claim 8, wherein the hook body is formed from stamped metal.

13. The tape measure hook of claim 8, wherein the slot includes a tapered entry region.

14. The tape measure hook of claim 8, further comprising a blade retention feature associated with the slot.

15. A method of using a tape measure hook having a slot configured to receive a blade of a cutting tool, the tape measure hook being secured to a distal end of a flexible tape of a tape measure, the method comprising:
inserting a blade of a cutting tool into the slot of the tape measure hook; and
moving the cutting tool relative to the workpiece while maintaining the blade within the slot to guide cutting along a line corresponding to the selected measurement length.

16. The method of claim 15, wherein inserting the blade includes inserting the blade through the slot until a cutting tip protrudes beyond a distal flange portion of the tape measure hook.

17. The method of claim 15, wherein the slot laterally restrains movement of the blade relative to a longitudinal axis of the flexible tape during cutting.

18. The method of claim 15, wherein inserting the blade includes the blade being retained by a blade retention member associated with the slot.

19. The method of claim 15, wherein the slot is perpendicular to a longitudinal axis of the flexible tape.

20. The method of claim 15, wherein the cutting tool is a knife.
